(19) United States
(12) Patent Application Publication
(10) Pub. No.: US 2024/0311618 A1
(43) Pub. Date: Sep. 19, 2024

(54) INTELLIGENT PROMPT EVALUATION AND ENHANCEMENT FOR GENERATIVE ARTIFICIAL INTELLIGENCE PROCESSING

(71) Applicant: Accenture Global Solutions Limited, Dublin (IE)

(72) Inventors: Narendranath Sukhavasi, Nizamabad (IN); Kanchanjot Kaur Phokela, New Delhi (IN); Kapil Singi, Bangalore (IN); Kuntal Dey, Rampurhat (IN); Vikrant Kaulgud, Pune (IN); Vibhu Saujanya Sharma, Bangalore (IN); Adam Patten Burden, Tampa, FL (US)

(73) Assignee: Accenture Global Solutions Limited, Dublin (IE)

(21) Appl. No.: 18/602,139

(22) Filed: Mar. 12, 2024

Related U.S. Application Data
(60) Provisional application No. 63/451,804, filed on Mar. 13, 2023.

(51) Int. Cl. G06N 3/0455

(52) U.S. Cl. CPC G06N 3/0455

(57) ABSTRACT

A method and system for evaluating and enhancing a prompt for use by a generative artificial intelligence processing model are disclosed. The method may include obtaining a prompt representing a natural language text for use by a generative artificial intelligence processing model, obtaining a prompt classifier trained to evaluate a classification of the prompt, and inputting the prompt to the prompt classifier to generate a classification of the prompt. The method may further include identifying an intent underlying the prompt and detecting an implicit constraint for the prompt based on the intent. The method may further include transforming the intent in the prompt into a constraint-enhanced intent based on the implicit constraint, generating an enhanced prompt based on the constraint-enhanced intent, and outputting the enhanced prompt for the generative artificial intelligence processing model.

### RELATED APPLICATION

This application claims priority to U.S. Provisional Patent Application No. 63/451,804, entitled “INTELLIGENT PROMPT EVALUATION AND ENHANCEMENT FOR NATURAL LANGUAGE PROCESSING” filed on Mar. 13, 2023, wherein the entirety of the above-referenced application is incorporated herein by reference.

### TECHNICAL FIELD

This application generally relates to generative artificial intelligence processing. In particular, this application describes intelligent prompt evaluation and enhancement for use by generative artificial intelligence processing.

### BACKGROUND

Natural language processing (NLP) models and tools such as Generative Pre-trained Transformer (GPT) take natural language text as inputs, which are referred to as prompts, and generate outputs based on the input prompts. For most applications, there is no obvious way to standardize the input prompts. Consequently, to generate a high-quality outcome, a user has to iteratively use the NLP tools, refine the input prompts over the iterations, and review the outcome of the refined prompts at each iteration.

### SUMMARY

The proposed solution relates to methods and systems for intelligently evaluating and enhancing prompts for use by generative artificial intelligence processing.

In one embodiment, a method for evaluating and enhancing a prompt for use by generative artificial intelligence processing is disclosed. The method is performed by a processor circuitry. The method may include obtaining a prompt representing a natural language text for use by a generative artificial intelligence processing model, obtaining a prompt classifier trained to evaluate a classification of the prompt, and inputting the prompt to the prompt classifier to generate a classification of the prompt. The method may further include, in response to the classification of the prompt being a predetermined category, identifying an intent underlying the prompt and detecting an implicit constraint for the prompt based on the intent. The implicit constraint may represent a domain knowledge associated with the intent and not being included in the prompt. The method may further include transforming the intent in the prompt into a constraint-enhanced intent based on the implicit constraint, generating an enhanced prompt based on the constraint-enhanced intent, and outputting the enhanced prompt for the generative artificial intelligence processing model.

In another embodiment, a system for evaluating and enhancing a prompt for use by generative artificial intelligence processing is disclosed. The system may include a memory having stored thereon executable instructions and a processor circuitry in communication with the memory. When executing the instructions, the processor circuitry may be configured to obtain a prompt representing a natural language text for use by a generative artificial intelligence processing model, obtain a prompt classifier trained to evaluate a classification of the prompt, and input the prompt to the prompt classifier to generate a classification of the prompt. The processor circuitry may be further configured to, in response to the classification of the prompt being a predetermined category, identify an intent underlying the prompt and detect an implicit constraint for the prompt based on the intent. The implicit constraint may represent a domain knowledge associated with the intent and not being included in the prompt. The processor circuitry may be further configured to transform the intent in the prompt into a constraint-enhanced intent based on the implicit constraint, generate an enhanced prompt based on the constraint-enhanced intent, and output the enhanced prompt for the generative artificial intelligence processing model.

In another embodiment, a product for evaluating and enhancing a prompt for use by generative artificial intelligence processing is disclosed. The product may include non-transitory machine-readable media and instructions stored on the machine-readable media. When being executed, the instructions may be configured to cause a processor circuitry to obtain a prompt representing a natural language text for use by a generative artificial intelligence processing model, obtain a prompt classifier trained to evaluate a classification of the prompt, and input the prompt to the prompt classifier to generate a classification of the prompt. The instructions may be further configured to cause the processor circuitry to, in response to the classification of the prompt being a predetermined category, identify an intent underlying the prompt and detect an implicit constraint for the prompt based on the intent. The implicit constraint may represent a domain knowledge associated with the intent and not being included in the prompt. The instructions may be further configured to cause the processor circuitry to transform the intent in the prompt into a constraint-enhanced intent based on the implicit constraint, generate an enhanced prompt based on the constraint-enhanced intent, and output the enhanced prompt for the generative artificial intelligence processing model.

The above embodiments and other aspects and alternatives of their implementations are explained in greater detail in the drawings, the descriptions, and the claims.

### BRIEF DESCRIPTION OF THE DRAWINGS

The present disclosure may be better understood with reference to the following drawings and description. The components in the below figures are not necessarily to scale. Moreover, in the figures, like-referenced numerals designate corresponding parts throughout the different views.

FIG. 1 shows an exemplary architecture for evaluating and enhancing prompts for use by generative artificial intelligence processing;

FIG. 2 shows an exemplary prompt evaluation and enhancement analytics logic for use by generative artificial intelligence processing;

FIG. 3 illustrates exemplary enhancements for prompts;

FIG. 4 illustrates an exemplary outcome by executing coding artifacts outputted by generative artificial intelligence processing tool based on the enhanced prompts; and

FIG. 5 shows an exemplary specific execution environment for executing the prompt evaluation and enhancement analytics logic to improve the quality of outcome outputted by the generative artificial intelligence processing tool.

### DETAILED DESCRIPTION

The disclosure will now be described in detail hereinafter with reference to the accompanied drawings, which form a part of the present disclosure, and which show, by way of illustration, specific examples of embodiments. Please note that the disclosure may, however, be embodied in a variety of different forms and, therefore, the covered or claimed subject matter is intended to be construed as not being limited to any of the embodiments to be set forth below. Please also note that the disclosure may be embodied as methods, devices, components, or systems. Accordingly, embodiments of the disclosure may, for example, take the form of hardware, software, firmware or any combination thereof.

Throughout the specification and claims, terms may have nuanced meanings suggested or implied in context beyond an explicitly stated meaning. Likewise, the phrase “in an embodiment” or “in an implementation” as used herein does not necessarily refer to the same embodiment or implementation and the phrase “in another embodiment” or “in another implementation” as used herein does not necessarily refer to a different embodiment or implementation. It is intended, for example, that claimed subject matter includes combinations of exemplary embodiments or implementations in whole or in part.

The systems and methods in the present disclosure may facilitate improvement of quality of outcome outputted by a generative artificial intelligence processing tool such as a Generative Pre-trained Transformer (GPT) by evaluating and enhancing prompts inputted by an end user and providing the enhanced prompts to the generative artificial intelligence processing tool for use to output outcomes such as coding artifacts. The coding artifacts may include, for example, source codes, complied codes, setup scripts, and generated objects. Here, the embodiments are discussed in the context of using of the generative artificial intelligence processing tool to generate coding artifacts base on the enhanced prompts. It would be appreciated that the systems and methods in the present disclosure may be applicable to other user scenarios and content generation utilizing the generative artificial intelligence processing tool.

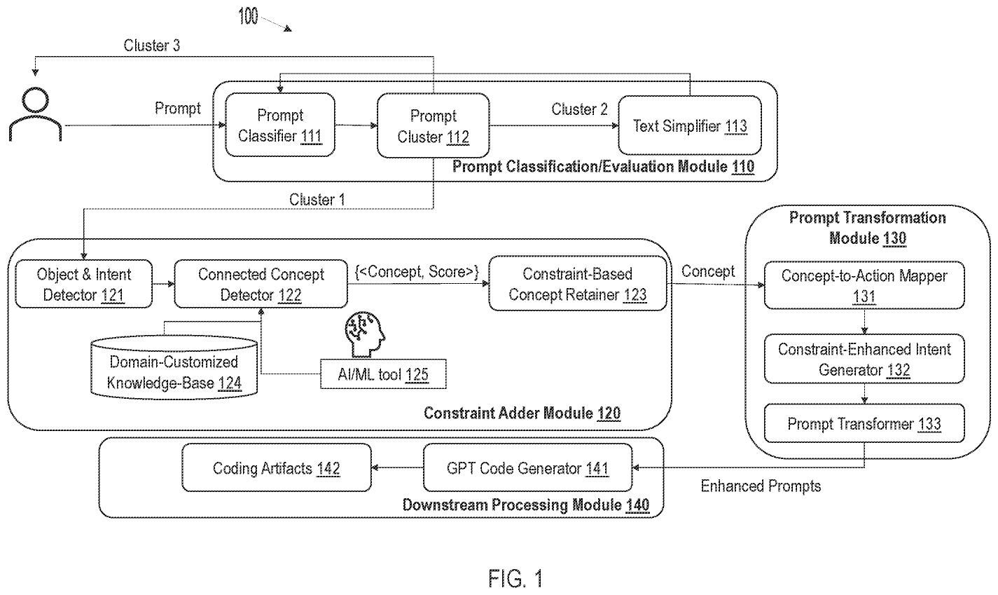

FIG. 1 shows an exemplary architecture 100 for evaluating and enhancing prompts for use by generative artificial intelligence processing. The architecture 100 may include prompt classification/evaluation module 110, constraint adder module 120, prompt transformation module 130, and downstream processing module 140. The prompt classification/evaluation module 110 may include prompt classifier 111, prompt cluster 112, and text simplifier 113. The constraint adder module 120 may include object and Intent detector 121, connected concepted detector 122, constraint-based concept retainer 123, domain-customized knowledge base 124 and artificial intelligence (AI)/machine learning (ML) tool 125. The prompt transformation module 130 may include concept-to-action mapper 131, constraint enhanced intent generator 132, and prompt transformer 133. The downstream processing module 140 may include GPT code generator 141.

The modules may operate collaboratively to evaluate and enhance prompts for use by the generative artificial intelligence processing as discussed in the present disclosure. The functions of the modules will be described by exemplary embodiments below. It should be appreciated that one or more modules may be removed from the exemplary architecture 100 or one or more other modules may be integrated into the exemplary architecture 100 to implement the technical solutions discussed in the present disclosure.

Herein, the term module may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the unit. A module is configured to perform functions and achieve goals such as those described in this disclosure, and may work together with other related modules, programs, and components to achieve those functions and goals.

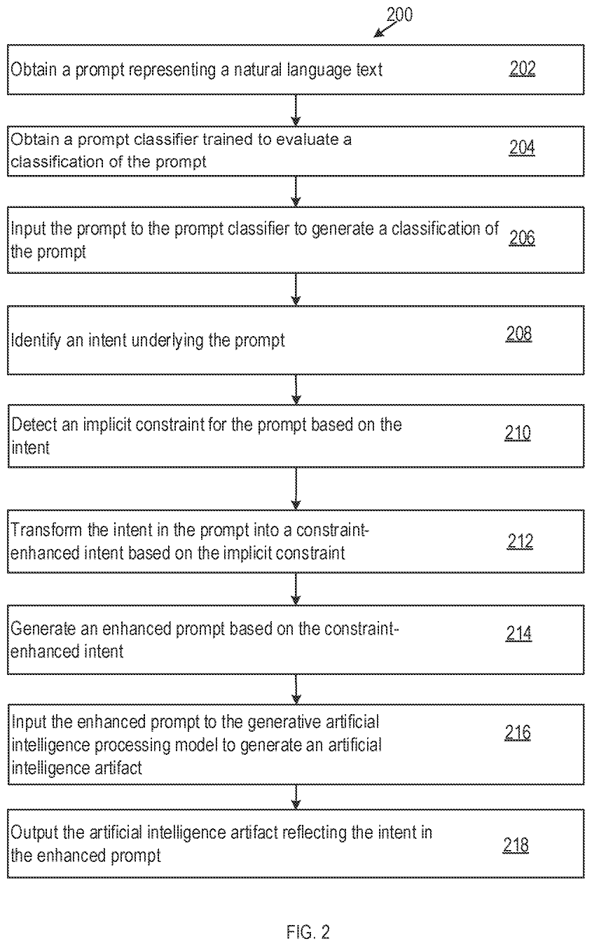

FIG. 2 shows an exemplary prompt evaluation and enhancement analytics logic (PEEAL) for use by the example generative artificial intelligence processing of this disclosure. The logical features in the PEEAL 200 will be discussed with reference to FIG. 1 and FIG. 2.

At the prompt classification/evaluation module 110, the PEEAL 200 may obtain a prompt representing a natural language text for use by a generative artificial intelligence processing model (202). In an example, the PEEAL 200 may receive a natural language text inputted by a user via a graphical user interface (GUI) and take the received text as the prompt for use by the generative artificial intelligence processing model. In another example, the PEEAL 200 may receive a user's audio data, convert the audio data into a natural language text using, for example, a speech-to-text tool, and take the converted natural language text as the prompt.

The PEEAL 200 may obtain a prompt classifier 111 trained to evaluate a classification of the prompt (204) and input the prompt to the prompt classifier 111 to generate a classification of the prompt (206). The prompt classifier may be trained with the existing natural language processing tools such as MonkeyLearn and TextBlob. The prompt may be classified into, for example, normal (or complete) prompt, complex prompt, vague prompt, incomplete prompt, and abstract prompt. A complex prompt may combine a plurality of sub-prompts.

In an implementation, the PEEAL 200 may generate, for example, three clusters at the prompt cluster 112. The normal prompts may be clustered into the first cluster, the complex prompts may be clustered into the second cluster, and the other types of prompts may be clustered into the third cluster.

If the prompt is a normal prompt clustered into the first cluster, the PEEAL 200 may pass over the prompt to the constraint adder module 120 for further processing. If the prompt is a complex prompt clustered into the second cluster, the PEEAL 200 may simplify the prompt into a plurality of sub-prompts at the text simplifier 113 and input each of the plurality of sub-prompts to the prompt classifier 111 for classification. If the prompt is clustered into the third cluster, the PEEAL 200 may return the prompt to the user, for example, via the graphical user interface for further refinements.

At the constraint adder module 120, the PEEAL 200 may identify an intent underlying the prompt (208). In an implementation, the PEEAL 200 may perform syntax and semantics analysis on the prompt to derive objects and intents in the prompt at the object and intent detector 121. Each intent may be associated with one or more objects, and may thus establish interconnection between two or more objects. For example, in an exemplary prompt “the full name of the student is stored as a combination of the first name and a last name,” the objects may be extracted as full name, student, first name and last name, and the intents are to combine and to store, and the first name and last name are interconnected.

If the prompt is a complex prompt, the PEEAL 200 may determine target sub-prompts from sub-prompts of the complex prompt. For example, for each of the sub-prompts of the complex prompt, if the sub-prompt is classified as a normal prompt at the prompt classifier 111, the PEEAL 200 may determine the sub-prompt as a target sub-prompt. Then, the PEEAL 200 may identify intents underlying the target sub-prompts as intents of the complex prompt.

After identifying the intent, the PEEAL 200 may detect an implicit constraint for the prompt based on the intent (210). The implicit constraint may represent a domain knowledge associated with the intent and not being included in the prompt.

In an implementation, the PEEAL 200 may utilize the domain-customized knowledge base 124 to detect a plurality of concepts ontologically associated with the intent and determine at least one of the plurality of concepts as an implicit constraint based on relevancy of the plurality of concepts with the intent. In the context of generating code artifacts using the generative artificial intelligence processing model, the domain-customizer knowledge base 124 may include, for example, knowledge graphs with respect to code programming.

For example, the PEEAL 200 may score the plurality of concepts based on relevancy of the plurality of concepts with the intent and determine a concept having a score exceeding a predetermined score threshold as the implicit constraint. The scoring may be implemented by document similarity computation mechanisms including term frequency-inverse document frequency (TF-IDF), probabilistic latent semantic analysis (PLSA), latent Dirichlet allocation (LDA), and embedding-distances. In the exemplary prompt above, the need to be “stored” may often be associated with a concept of storing on a device, in a cloud, etc., while the “combination” may be associated with the concept of computing algorithmically.

In another implementation, the PEEAL 200 may utilize an AI/ML tool 125 to obtain a concept detector 122 trained to detect concepts associated with the intent in a specific knowledge domain and input the intent to the concept detector 122 to obtain a plurality of concepts associated with the intent. The concept detector 122 may be implemented using word embeddings and neural network or other applicable machine learning models.

Then, the PEEAL 200 may determine at least one of the plurality of concepts as an implicit constraint based on relevancy of the plurality of concepts with the intent. In an implementation, the PEEAL 200 may score the plurality of concepts based on relevancy of the plurality of concepts with the intent, and determine a concept having a score exceeding a predetermined score threshold as the implicit constraint.

The PEEAL 200 may retain all the concepts associated with the intent that have scores above a predetermined score threshold and take the concepts as the implicit constraints for the prompt. For example, concepts such as encryption and masking may be associated with the concept of store given that full name is associated with the concept of personally identifiable information (PII) and thus these concepts may be retained at the constraint-based concept retainer 123 and passed over to the prompt transformation module 130 for further processing.

At the prompt transformation module 130, the PEEAL 200 may transform the intent in the prompt into a constraint-enhanced intent based on the implicit constraint (212) and generate an enhanced prompt based on the constraint-enhanced intent (214). In an implementation, the PEEAL 200 may map the implicit constraint to an executable action for concatenating the implicit constraint with the intent at the concept-to-action mapper. For example, the implicit constraint encryption may be concatenated with store intent.

The executable action may include concatenating the implicit constraint with the intent by adding an adjective form of the implicit constraint to the appropriate objects connected with the intent. Alternatively, or additionally, the executable action may include concatenating the implicit constraint with the intent by adding a verb/adverb form of the implicit constraint to the intent.

Then, the PEEAL 200 may execute the executable action to generate constraint-enhanced intent for the prompt at the constraint enhanced intent generator 132 so as to transform the input prompt into the enhanced prompt based on constraint-enhanced intent at the prompt transformer 133. For example, the input prompt “the full name of the student is stored as a combination of the first name and a last name” may be transformed into the enhanced prompt “the full name of the student is encrypted and stored as a combination of the first name and a last name” or “the encrypted full name of the student is stored as a combination of the first name and a last name.”

After obtaining the enhanced prompt, the PEEAL 200 may store the enhanced prompt into a data storage such as a local relational database or a cloud storage for validation or audit. For example, the subject matter expert may later review the stored enhanced prompt to determine whether the prompt is enhanced properly.

At the downstream processing module 140, the PEEAL 200 may output the enhanced prompt to a generative artificial intelligence processing model for downstream processing. The downstream processing may include, for example, programing code generation based on the enhanced prompt, query searching based on the enhanced prompt, commenting on the documents based on the enhanced prompt, and the like.

Specifically, the PEEAL 200 may execute the generative artificial intelligence processing model by inputting the enhanced prompt to the generative artificial intelligence processing model to generate an artificial intelligence artifact reflecting an intent in the enhanced prompt (216) and output the artificial intelligence artifact reflecting the intent in the enhanced prompt (218). For example, the PEEAL 200 may display the artificial intelligence artifact via a graphical user interface.

Take the programming code generation as an example, the PEEAL 200 may execute the GPT code generator 141 by inputting the enhanced prompt to the GPT code generator 141 such that the GPT code generator 141 can generate the coding artifacts 142 such as program codes based on the enhanced prompt. Then, the PEEAL 200 may output the coding artifacts 142 to the user. For example, the PEEAL 200 may execute the coding artifacts 142 to perform a coding function implementing an intent in the enhanced prompt.

Further in the disclosure below, various exemplary working examples are provided to further describe the methods and systems of the present disclosure.

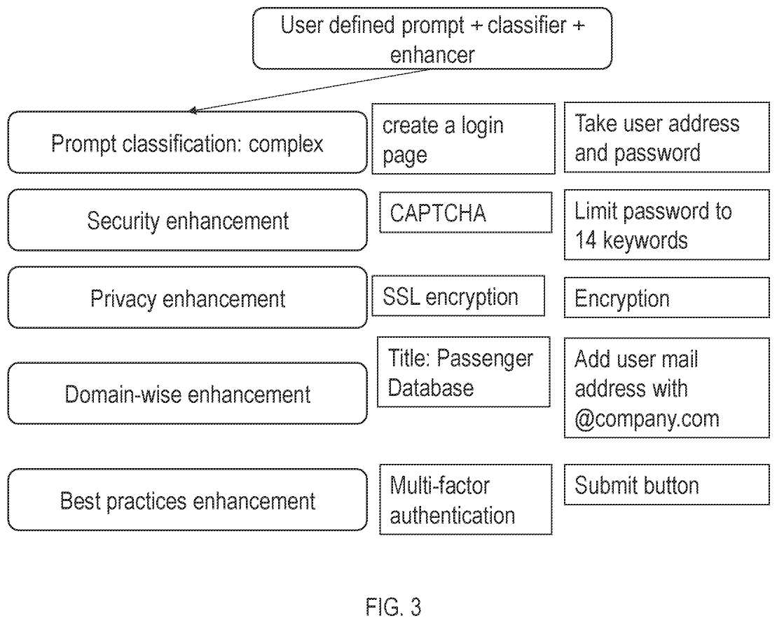

In an exemplary working example, the input prompt is “create a login page for taking user address and password,” the PEEAL 200 may classify the prompt as a complex prompt and simplify the prompt into two sub-prompts “create a login page” and “take user address and password” in the prompt classification/evaluation module 110. Then, the PEEAL 200 may perform enhancements on the sub-prompts. As shown in FIG. 3, the enhancements may include security enhancement, privacy enhancement, domain-wise enhancement, and best practices enhancement. As a result, the two sub-prompts are transformed into enhanced prompts “create a login page with title passenger database” and “create user-address with @company.com and password with multi-factor authentication with SSL encryption and Captcha with submit button” at the constraint adder module 120.

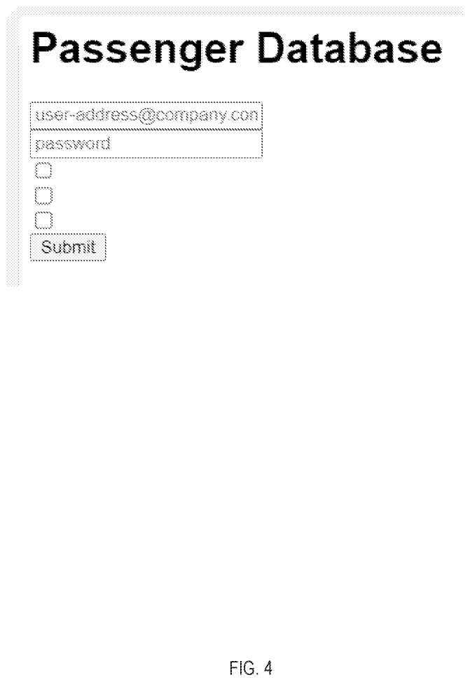

Table 1 is a comparison of coding artifacts generated at the GPT code generator 141 based on the input prompt “create a login page for taking user address and password” and the enhanced prompts “create a login page with title passenger database” and “create user-address with @company.com and password with multi-factor authentication with SSL encryption and Captcha with submit button.” As shown in Table 1, after the prompt enhancement, the GPT code generator 141 may generate more wholesome and higher-quality coding artifacts. FIG. 4 shows a resulting login page by executing the code artifacts generated based on the enhanced prompts.

TABLE 1
comparison of coding artifacts

| Coding artifacts generated | Coding artifacts generated |
|---|---|
| prior to enhancement | after enhancement |
| var express = require(‘express’); | var loginPage = document.createElement(‘div’); |
| var app = express( ); | loginPage.innerHTML = ‘<h1>Passenger Database</h1>’; |
| app.get(‘/’, function(req, res) { | document.body.appendChild(loginPage); |
| res.send(‘<form action=“/login” | var userAddress = document.createElement(‘div’); |
| method=“post”>’ + | userAddress.innerHTML = ‘<input type=“text” |
| ‘<div><label>Address:</label>’ + | placeholder=“user-address@company.com”>’; |
| ‘<input type=“text” | document.body.appendChild(userAddress); |
| name=“address”/></div>’ + | var password = document.createElement(‘div’); |
| ‘<div><label>Password:</label>’ + | password.innerHTML = ‘<input type=“password” |
| ‘<input type=“password” | placeholder=“password”>’; |
| name=“password”/></div>’ + | document.body.appendChild(password); |
| ‘<div><input type=“submit” | var multiFactorAuthentication = |
| value=“Submit”/></div>’ + | document.createElement(‘div’); |
| ‘</form>’); | multiFactorAuthentication.innerHTML = ‘<input |
| }); | type=“checkbox” name=“multi-factor authentication”>’; |
| app.post(‘/login’, function(req, res) { | document.body.appendChild(multiFactorAuthentication); |
| res.send(‘login: ’ + req.body.address + | var SSLencryption = document.createElement(‘div’); |
| ‘<br>’ + | SSLencryption.innerHTML = ‘<input type=“checkbox” |
| ‘password: ’ + req.body.password); | name=“SSL encryption”>’; |
| }); | document.body.appendChild(SSLencryption); |
| app.listen(3000); | var captcha = document.createElement(‘div’); |
| | captcha.innerHTML = ‘<input type=“checkbox” |
| | name=“captcha”>’; |
| | document.body.appendChild(captcha); |
| | var submitButton = document.createElement(‘div’); |
| | submitButton.innerHTML = ‘<input type=“submit” |
| | value=“Submit”>’; |
| | document.body.appendChild(submitButton); |

In another exemplary working example, the input prompt is “call to API,” the PEEAL 200 may classify the prompt as a normal prompt. Then, the PEEAL 200 may perform enhancements on the normal prompt to transform the prompt into enhanced prompt “call to API with authentication for status request.”

Table 2 shows a comparison of coding artifacts generated at the GPT code generator 141 based on the input prompt “call to API” and the enhanced prompt “call to API with authentication for status request.” Likewise, after the prompt enhancement, the GPT code generator 141 is enabled to generate more desirable coding artifacts.

TABLE 2
comparison of coding artifacts

| Coding artifacts generated | Coding artifacts generated |
|---|---|
| prior to enhancement | after enhancement |
| var xhr = new XMLHttpRequest( ); | var xhr = new XMLHttpRequest( ); |
| xhr.open(‘GET’, | xhr.open(‘GET’, ‘https://api.github.com/rate_limit’, true); |
| ‘https://api.github.com/users/james- | xhr.setRequestHeader(‘Authorization’, ‘token ’ + |
| priest’, true); | ‘<token>’); |
| xhr.onreadystatechange = function( ) { | xhr.onreadystatechange = function( ) { |
| if (xhr.readyState == 4) { | if (xhr.readyState == 4) { |
| var data = | var data = JSON.parse(xhr.responseText); |
| JSON.parse(xhr.responseText); | console.log(data); |
| console.log(data); | } |
| } | } |
| }; | xhr.send( ); |
| xhr.send( ); | |

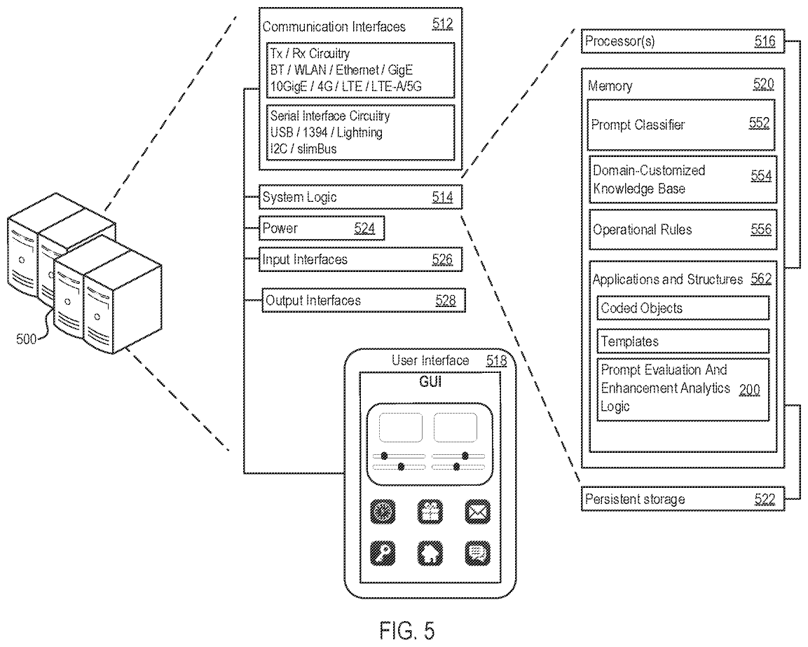

FIG. 5 shows an exemplary specific execution environment for executing the prompt evaluation and enhancement analytics logic 500 as described above. The execution environment 500 may include system logic 514 to support execution of the logics described above. The system logic 512 may include processors 516, memory 520, and/or other circuitries. The memory 520 may include prompt classifier 552, domain-customized knowledge base 554, and operational rules 556. The memory 520 may further include applications and structures 662, for example, coded objects, machine instructions, templates, or other structures to support identifying intent underlying the prompt, detecting implicit constraint from the prompt, transforming the intent in the prompt into a constraint-enhanced intent, generating an enhanced prompt based on the constraint-enhanced intent, or other tasks described above. The applications and structures may implement the prompt evaluation and enhancement analytics logic 200.

The execution environment 500 may also include communication interfaces 512, which may support wireless, e.g. Bluetooth, Wi-Fi, WLAN, cellular (4G, LTE/A, 5G), and/or wired, Ethernet, Gigabit Ethernet, optical networking protocols. The communication interfaces 512 may also include serial interfaces, such as universal serial bus (USB), serial ATA, IEEE 1394, lighting port, I2C, slimBus, or other serial interfaces. The execution environment 500 may include power functions 524 and various input interfaces 526. The execution environment may also include a user interface 518 that may include human-to-machine interface devices and/or graphical user interfaces (GUI). In some implementations, the system logic 514 may be distributed over one or more physical machines or be implemented as one or more virtual machines.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CD-ROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

What is claimed is:

1. A method comprising:
obtaining, with a processor circuitry, a prompt representing a natural language text for use by a generative artificial intelligence processing model;
obtaining, with the processor circuitry, a prompt classifier trained to evaluate a classification of the prompt;
inputting, with the processor circuitry, the prompt to the prompt classifier to generate a classification of the prompt;
in response to the classification of the prompt being a predetermined category, identifying, with the processor circuitry, an intent underlying the prompt;
detecting, with the processor circuitry, an implicit constraint for the prompt based on the intent, the implicit constraint representing a domain knowledge associated with the intent and not being included in the prompt;
transforming, with the processor circuitry, the intent in the prompt into a constraint-enhanced intent based on the implicit constraint;
generating, with the processor circuitry, an enhanced prompt based on the constraint-enhanced intent; and
outputting, with the processor circuitry, the enhanced prompt for the generative artificial intelligence processing model.

2. The method of claim 1, the method further comprises:
executing the generative artificial intelligence processing model by inputting the enhanced prompt to the generative artificial intelligence processing model to generate an artificial intelligence artifact reflecting an intent in the enhanced prompt; and
outputting the artificial intelligence artifact reflecting the intent in the enhanced prompt.

3. The method of claim 2, where the outputting the artificial intelligence artifact comprises:
displaying the artificial intelligence artifact via a user interface.

4. The method of claim 2, where the artificial intelligence artifact is program codes, and the outputting the artificial intelligence artifact comprises:
executing the program codes to perform a coding function implementing an intent in the enhanced prompt.

5. The method of claim 1, where the detecting the implicit constraint for the prompt based on the intent comprises:
utilizing a domain-customized knowledge base to detect a plurality of concepts ontologically associated with the intent; and
determining at least one of the plurality of concepts as an implicit constraint based on relevancy of the plurality of concepts with the intent.

6. The method of claim 1, where the detecting the implicit constraint for the prompt based on the intent comprises:
obtaining a concept detector trained to detect concepts associated with the intent in a specific knowledge domain;
inputting the intent to the concept detector to obtain a plurality of concepts associated with the intent; and
determining at least one of the plurality of concepts as an implicit constraint based on relevancy of the plurality of concepts with the intent.

7. The method of claim 6, where the determining the at least one of the plurality of concepts as the implicit constraint comprises:
scoring the plurality of concepts based on relevancy of the plurality of concepts with the intent; and
determining a concept having a score exceeding a predetermined score threshold as the implicit constraint.

8. The method of claim 1, where the transforming the intent in the prompt into the constraint-enhanced intent based on the implicit constraint comprises:
mapping the implicit constraint to an executable action for concatenating the implicit constraint with the intent; and
executing the executable action to generate constraint-enhanced intent for the prompt.

9. The method of claim 1, where the classification of the prompt comprises a normal prompt or a complex prompt combining a plurality of sub-prompts, and the identifying the intent underlying the prompt comprises:
in response to the classification of the prompt being a normal prompt, identifying the intent underlying the prompt comprises.

10. The method of claim 9, where the method further comprises:
in response to the classification of the prompt being a complex prompt, simplifying the prompt into a plurality of sub-prompts; and
inputting each of the plurality of sub-prompts to the prompt classifier to classify the sub-prompts respectively.

11. The method of claim 10, where the method further comprises:
determining target sub-prompts from the plurality of sub-prompts, each of the target sub-prompts being classified as a normal prompt; and
identifying intents underlying the target sub-prompts as intents of the complex prompt.

12. The method of claim 1, where the identifying the intent underlying the prompt comprises:
performing syntax and semantics analysis on the prompt to derive the intent.

13. The method of claim 1, where the method further comprises:
storing the enhanced prompt into a storage for validation.

14. A system comprising:
a memory having stored thereon executable instructions; and
a processor circuitry in communication with the memory, the processor circuitry when executing the executable instructions configured to:
obtain a prompt representing a natural language text for use by a generative artificial intelligence processing model;
obtain a prompt classifier trained to evaluate a classification of the prompt;
input the prompt to the prompt classifier to generate a classification of the prompt;
in response to the classification of the prompt being a predetermined category, identify an intent underlying the prompt;
detect an implicit constraint for the prompt based on the intent, the implicit constraint representing a domain knowledge associated with the intent and not being included in the prompt;
transform the intent in the prompt into a constraint-enhanced intent based on the implicit constraint;
generate an enhanced prompt based on the constraint-enhanced intent; and
output the enhanced prompt for the generative artificial intelligence processing model.

15. The system of claim 14, the processor circuitry is further configured to:
execute the generative artificial intelligence processing model by inputting the enhanced prompt to the generative artificial intelligence processing model to generate an artificial intelligence artifact reflecting an intent in the enhanced prompt; and
output the artificial intelligence artifact reflecting the intent in the enhanced prompt.

16. The system of claim 15, where the artificial intelligence artifact is program codes, and the processor circuitry is configured to:
execute the program codes to perform a coding function implementing an intent in the enhanced prompt.

17. The system of claim 14, where the processor circuitry is configured to:
utilize a domain-customized knowledge base to detect a plurality of concepts ontologically associated with the intent; and
determine at least one of the plurality of concepts as an implicit constraint based on relevancy of the plurality of concepts with the intent.

18. The system of claim 14, where the processor circuitry is configured to:
obtain a concept detector trained to detect concepts associated with the intent in a specific knowledge domain;
input the intent to the concept detector to obtain a plurality of concepts associated with the intent; and
determine at least one of the plurality of concepts as an implicit constraint based on relevancy of the plurality of concepts with the intent.

19. The system of claim 14, where the classification of the prompt comprises a normal prompt or a complex prompt combining a plurality of sub-prompts, and the processor circuitry is configured to:
in response to the classification of the prompt being a normal prompt, identify the intent underlying the prompt comprises.

20. A non-transitory machine-readable media, having instructions stored on the machine-readable media, the instructions configured to, when executed, cause a machine to:
obtain a prompt representing a natural language text for use by a generative artificial intelligence processing model;
obtain a prompt classifier trained to evaluate a classification of the prompt;
input the prompt to the prompt classifier to generate a classification of the prompt;
in response to the classification of the prompt being a predetermined category, identify an intent underlying the prompt;
detect an implicit constraint for the prompt based on the intent, the implicit constraint representing a domain knowledge associated with the intent and not being included in the prompt;
transform the intent in the prompt into a constraint-enhanced intent based on the implicit constraint;
generate an enhanced prompt based on the constraint-enhanced intent; and
output the enhanced prompt for the generative artificial intelligence processing model.
